(19) United States
(12) Patent Application Publication
(10) Pub. No.: US 2014/0047036 A1
(43) Pub. Date: Feb. 13, 2014

(54) METHOD AND APPARATUS FOR PROVIDING A USER WITH CONTEMPORANEOUS STRATEGY PROVIDER INFORMATION, PREFERENCES AND DECISIONS IN A COMPUTER IMPLEMENTED PLATFORM

(71) Applicants: Lior Nabat, Rechovot (IL); Gil Eyal, Cochav Yair (IL)

(72) Inventors: Lior Nabat, Rechovot (IL); Gil Eyal, Cochav Yair (IL)

(73) Assignee: Tradency INC, Tortola (VG)

(21) Appl. No.: 14/003,574

(22) PCT Filed: Mar. 8, 2012
(86) PCT No.: PCT/IL12/00111

§ 371 Date: Oct. 11, 2013

(30) Foreign Application Priority Data
Mar. 8, 2011 (GB) 1103944.3

(51) Int. Cl. H04L 29/08

(52) U.S. Cl. CPC H04L 67/10
USPC 709/205

(57) ABSTRACT

A method for contemporaneously displaying data on a screen; the method comprising the steps of: i. receiving a request for facilitating the selection of an executable operation from a list of possible operations ii. retrieving a first on line data related to a change in a value of the outcomes of executing said operation; iii. retrieving from a data repository a second data related to preferences, activities and performance of one or more strategy providers; and iv. contemporaneously transmitting the first data and the second data to a remote computerised device for making the first data and the second data contemporaneously available on a display of the remote computerised device.

### FIELD OF THE INVENTION

The present invention generally relates to means and methods for contemporaneously displaying data on a screen, in particular to facilitate a user to execute decisions whilst monitoring decisions made by others.

### BACKGROUND OF THE INVENTION

Participants in complex systems and environments often need inputs of information that they can readily see on their computer screens to help them make optimal decisions.

PCT application WO2011006153A1 to MITTAL. Hitesh et al. discloses a system for redirecting, electronic trade orders submitted from a trader via an electronic trade routing network to a selected destination. The trade order routing facilities are coupled with an electronic trade routing network and a plurality of trade venues including one or more third party broker dealer systems and one or more alternative trading systems. The trade order routing facilities receives an electronic order to trade a tradable asset from a trader, identify the trade venue that is the destination of the order, and electronically route the order via an electronic trade routing network to the destination trade venue as a first trade order The trade order routing facilities also monitors the electronic trade order at the destination trade venue to determine the number of shares that have been executed at the destination trade venue for the order.

US application US20110016036A1 to Rosenberg, Richard et al discloses Systems and methods of facilitating trades of instruments. A master node and a plurality of intermediate nodes store counterparty credit matrices. Trades are executed based on the information stored in these matrices. The systems and methods allow selection of trading options that not only accept or reject a trade, but also can indicate a credit status to be assigned to counterparty to the trade.

US application US20110016035A1 to Rosenthal, Leslie et al. discloses method and system for providing automatic execution of black box trading strategies for electronic trading. A black box trading entity is created from two or more real or synthetic trading entities including real or synthetic contracts or financial instruments. The black box trading entity is automatically traded via one or more electronic trading exchanges on a client device and/or a server device and/or a combination thereof, thereby making the execution of electronic trades for the black box trading entity faster and more reliable than when executing on one network device alone.

It is a long felt and unmet need to provide methods and means for contemporaneously displaying data on a screen from various sources so that a participant in any decision making process may receive high quality online information that the user can act upon in real time.

### SUMMARY OF THE INVENTION

An object of the present invention discloses a method for contemporaneously displaying data on a screen; the method comprising the steps of:
i. receiving a request for facilitating the selection of an executable operation from a list of possible operations
ii. retrieving a first on fine data related to a change in a value of the outcomes of executing said operation;
iii. retrieving from a data repository a second data related to preferences, activities and performance of one or more strategy providers; and
iv. contemporaneously transmitting the first data and the second data to a remote computerised device for making the first data and the second data contemporaneously available on a display of the remote computerised device.

A further object of the present invention discloses the aforementioned method further comprising a step of receiving an instruction for buying a financial instrument

A further object of the present invention discloses the aforementioned method further comprising a step of receiving an instruction for carrying out a medical or surgical procedure

A further object of the present invention discloses the aforementioned method further comprising a step of receiving an instruction for carrying out or dispensing a drug regime.

A further object of the present invention discloses the aforementioned method further comprising a step of receiving an instruction for carrying out a logistical procedure

A further object of the present invention discloses the aforementioned method further comprising a step of receiving an instruction for carrying out a processing operation

A further object of the present invention discloses the aforementioned method further comprising a step of executing said instruction.

A further object of the present invention discloses the aforementioned method further wherein the manner of said executing is selected from the group consisting of operating, communicating, exchanging, simulating, deciding, replacing, directing, placing, locating, supplying, determining, finding, selecting, acquiring, removing, divesting, adding, subtracting, dividing, contracting, contacting, buying, selling, displaying, calculating, downloading, uploading, pushing, pulling and sending.

A further object of the present invention discloses the aforementioned method further comprising receiving a selling order for selling a financial instrument.

A further object of the present invention discloses the aforementioned method further wherein said financial instrument comprises one member of the group consisting of securities, options, shares, bonds and mutual funds.

A further object of the present invention discloses the aforementioned method further comprising executing the selling order.

A further object of the present invention discloses the aforementioned method further wherein the retrieving further comprising retrieving a third data related to a trend for said outcome and the contemporaneously transmitting further comprises the third data.

A further object of the present invention discloses the aforementioned method further wherein the first data further comprises a data related to a range in value of said outcome at predefined time frames.

A further object of the present invention discloses the aforementioned method further wherein said outcome is a difference between between a first value and a second value of an object or instrument.

A further object of the present invention discloses the aforementioned method comprising steps of displaying on the remote computerised device said first data and second data in separate fields on said display.

A further object of the present invention discloses the aforementioned method comprising steps of displaying on the remote computerised device said third data are displayed in at least one field on said display.

A further object of the present invention provides a computerized apparatus for contemporaneously displaying data on a screen related to contemporaneous strategy provider information, preferences and decisions in a computer implemented operating platform ; the computerized apparatus comprising:
v. a receiver module (110) configured for receiving a request for selecting of an executable operation from a list of possible operations
vi. a processor (120) configured for retrieving a first data related to a change in a value of the outcomes of executing said operation and for retrieving a second data related to preferences, performance and activity of strategy providers;
vii. a transmitter module (130) configured for contemporaneously transmitting the first data and the second data; for making the first data and the second data contemporaneously available to the user on a display on a remote computer device wherein the processor is further configured for retrieving an information of a third data related to a trend for the outcomes of executing said operation and wherein the transmitter module is further configured for contemporaneously transmitting the third data.

A further object of the present invention provides the aforementioned computerised apparatus wherein said receiver module is configured to receive an instruction for buying a financial instrument

A further object of the present invention provides the aforementioned computerised apparatus configured to carry out an instruction for carrying out a medical or surgical procedure

A further object of the present invention provides the aforementioned computerised apparatus wherein said receiver module is configured to receive an instruction for carrying out a drug regime.

A further object of the present invention provides the computerised apparatus wherein said receiver module is configured to receive an instruction for carrying out a logistical procedure

A further object of the present invention provides the computerised apparatus wherein said receiver module is configured to receive an instruction for carrying out a processing operation

A further object of the present invention provides the computerised apparatus wherein said receiver module is configured to receive a step of executing said instruction.

A further object of the present invention provides the computerised apparatus wherein the manner of said executing is selected from the group consisting of operating, communicating, exchanging, replacing, directing, placing, locating, supplying, comparing, deciding, diagnosing, commanding, determining, finding, selecting, acquiring, removing, divesting, adding, subtracting, contracting, contacting, buying, selling, displaying, calculating, lending, borrowing, hiring, downloading, uploading, pushing, pulling and sending.

A further object of the present invention provides the computerised apparatus further configured for receiving a selling order for selling a financial instrument.

A further object of the present invention provides the computerised apparatus wherein said instrument comprises one member of the group consisting of securities, options, shares, bonds and mutual funds.

A further object of the present invention provides the computerised apparatus configured for executing the selling order.

A further object of the present invention provides the computerised apparatus wherein said processor is configured for retrieving a third data related to a trend for said outcome and the contemporaneously transmitting further comprises the third data.

A further object of the present invention provides the computerised apparatus wherein the processor is configured for processing said first data wherein said first data is related to a range in value of said outcome at predefined time frames.

A further object of the present invention provides the computerised apparatus wherein said transmitter module is configured to transmit said outcome wherein said outcome is a difference between between a first value and a second value of an object.

One exemplary embodiment of the disclosed subject matter comprises a method for providing a trader with contemporaneous strategy provider information, preferences and decisions in a computer implemented trading platform; the method comprising the steps of: receiving a request from a trader for facilitating trading of a financial instrument; retrieving a first data related to a change in a value of the financial instrument; retrieving a second data related to preferences, financial activities and financial performance of one or more strategy providers; and contemporaneously transmitting the first data and the second data for making the first data and the second data is contemporaneously available to said trader. According, to some embodiments the method further comprises a step of receiving a buying order for buying the financial instrument. According to some other embodiments, the method further comprising a step of executing the buying order. According to some other embodiments the method further comprising receiving a selling order for selling the financial instrument. According to some other embodiments, the method further comprising executing the selling order. According to some other embodiments the retrieving further comprising retrieving a third data related to a market trend for the financial instrument and the contemporaneously transmitting further comprises the third data. According to some other embodiments, wherein the first data further comprises a data related to a range in value of the financial instrument on predefined time frames. According, to some other embodiments, the financial instrument is a rate between a first currency and a second currency. According to some other embodiments, the financial instrument comprises one member of the group consisting of securities, options, shares, bonds and mutual funds.

Another exemplary embodiment of the disclosed subject matter is a computerized apparatus for providing a trader with contemporaneous strategy provider information, preferences and decisions in a computer implemented trading platform ; the computerized apparatus comprising: a receiver module (110) configured for receiving a request for facilitating of trading of financial instrument; a processor (120) configured for retrieving a first data related to a change in a value of the financial instrument and for retrieving a second data related to preferences, financial performance and financial activity of strategy providers; a transmitter module (130) configured for contemporaneously transmitting the first data and the second data; for making the first data and the second data contemporaneously available to the user. According to some other embodiments The computerized apparatus of claim 10; wherein the processor is further configured for retrieving an information of a third data related to a market trend for the financial instrument and wherein the transmitter module is further configured for contemporaneously transmitting the third data. According to some other embodiments, the first data further related to a range in value of the financial instrument on predefined time frame According to some other embodiments the financial instrument is a rate between a first currency and a second currency. According to some other embodiments, the financial instrument comprises one member of the group consisting of securities, options, shares, bonds and mutual funds. According to some other embodiments, the computerized apparatus further comprises a storage unit (140) for storing the first data and the second data.

Another exemplary embodiment of the disclosed subject matter is a method for providing a trader with contemporaneous strategy provider information, preferences and decisions in a computer implemented trading platform the method comprising: executing a request for facilitating of a trading of a financial instrument; receiving a first data related to a value change of the financial instrument; receiving a second data related to preferences, financial performance and financial activity of one or more strategy providers; and contemporaneously providing accessibility to the first data and the second data. According to some embodiments, the method, further comprising a step of executing a buying order for buying the financial instrument. According to some embodiments, the method further comprising a step of executing a selling order for selling the financial instrument. According to some embodiments, the method further comprising receiving a third data related to a market trend for the financial instrument. According to some embodiments, the method further comprises contemporaneously displaying the first data, the second data and the third data on a computerized display thereby to provide a comprehensive information to a user. According to some embodiments, the first data further comprises a range in value of the financial instrument on predefined time frames. According to some embodiments, the financial instrument is a rate between a first currency and a second currency. According to some embodiments, the financial instrument comprises one member of the group consisting of securities. options, shares, bonds and mutual funds. According to some embodiments, the contemporaneously providing accessibility to the first data and the second data comprises contemporaneously displaying the first data and then second data on a computerized display. According to some embodiments, the contemporaneously providing accessibility to the first data and the second data comprises contemporaneously playing audio related to the first data and of the second data.

Another exemplary embodiment of the disclosed subject matter is a computerized apparatus for providing a trader with contemporaneous strategy provider information, preferences and decisions in a computer implemented trading platform: a processor (310) for executing a request for facilitating a trading of said financial instrument; a receiver module (320) for receiving a first data related to a value change of the financial instrument and for receiving a second data related to preferences of one or more strategy providers; and a display unit (330) for contemporaneously displaying the first data and the second data on a computerized display. According to some embodiments, the processor is further configured for executing a buying order for buying the financial instrument. According to some embodiments, the processor is further configured for executing a selling order for selling the financial instrument. According to some embodiments, the receiver module is further configured for receiving a third data related to a market trend for the financial instrument. According to some embodiments, the display unit is further configured for contemporaneously displaying the first data, the second data and the third data on a computerized display thereby to provide comprehensive information to a user. According to some embodiments, the data further comprises a range in value of the financial instrument on pre defined time frames and wherein the signals are displayed on the computerized display. According to some embodiments, the financial instrument is a rate between a first currency and a second currency. According to some embodiments, the financial instrument comprises one member of the group consisting of securities,. options. shares, bonds and mutual funds. According to some embodiments, the display unit further comprises a first button for executing the buy order. According to some embodiments, the display unit further comprises a second button for executing the sell order. According to some embodiments, computer apparatus, further comprising an audio unit (350) for contemporaneously displaying the first data and the second data on a computerized display. According to some embodiments, the computer apparatus of claim 26, further comprising a transmitter (340) for transmitting the request for facilitating a trading of said financial instrument.

Another exemplary embodiment of the disclosed subject matter is a method for facilitating a trader to imitate financial activities of an expert trader; the method comprising the steps of: receiving a request from a trader for facilitating trading of a financial instrument; retrieving a data related to one or more trades of one or more strategy providers; transmitting the data to said trader in real time; wherein the data is accessible to the trader in real time thereby to facilitate the trader to mirror the one or more trades of the one or more strategy providers.

Another exemplary embodiment of the disclosed subject matter is a computerized apparatus for facilitating a trader to imitate financial activities of an expert trader; the computerized apparatus comprising: a receiver module (110) configured for receiving a request for facilitating of trading of financial instrument; a processor (120) configured for retrieving a first data related to one or more trades of one or more strategy providers and for directing the first data to the trader; and a transmitter module (130) configured transmitting the data to said trader in real time ; wherein the data is accessible to the trader in real time thereby to facilitate the trader to mirror the one or more trades of the one or more strategy providers.

Another exemplary embodiment of the disclosed subject matter is a method for facilitating a trader to imitate financial activities of an expert trader; the method comprising: executing a request for facilitating of a trading of a financial instrument; receiving a data related to one or more trades of one or more strategy providers; and displaying the data to the trader in real time thereby to facilitate the trader to mirror the one or more trades of the one or more strategy providers.

Another exemplary, embodiment of the disclosed subject matter is a computerized apparatus for facilitating a trader to imitate financial activities of an expert: a processor (310) configure for executing a request for facilitating of a trading of a financial instrument; a receiver module (320) configured for receiving a data related to one or more trades of one or more strategy providers; and a display unit (330) configured for displaying the data to the trader in real time thereby to facilitate the trader to mirror the one or more trades of the one or more strategy providers.

Another exemplary embodiment of the disclosed subject matter is a computer program placed on a magnetic readable media for trading of a financial instrument; the computer program comprises: a first program instruction for executing a request for facilitating trading of financial instrument; a second program instruction for receiving a first data related to a value change of the financial instrument; a third program instruction for receiving a second data related to preferences, financial performance and financial activity of one or more strategy providers ; and a fourth program instruction for contemporaneously displaying the first data and the second data on a computerized display.

### BRIEF DESCRIPTION OF THE DRAWINGS

In order to better understand the invention and its implementation in a practice, a plurality of embodiments will now be described, by way of non-limiting example only, with reference to the accompanying drawings, in which

FIG. 1 shows a schematic block diagram of a centralized machine for facilitating trading of a financial instrument, for facilitating simulating or carrying out a medical or surgical procedure or treatment program or drug regime, or other activities of industrial application in accordance with exemplary embodiments of the present invention.

FIG. 2 shows a flowchart diagram of a centralized method for facilitating trading of a financial instrument, for facilitating simulating or carrying out a medical or surgical procedure or treatment program or drug regime, or other activities of industrial application in accordance with exemplary embodiments of the present invention.

FIG. 3 shows a schematic block diagram of a computerized apparatus for facilitating trading of a financial instrument, for facilitating simulating or carrying out a medical or surgical procedure or treatment program or drug regime, or other activities of industrial application in accordance with exemplary embodiments of the present invention.

FIG. 4 shows a flowchart diagram of a computerized method for facilitating trading of a financial instrument, for facilitating simulating or carrying out a medical or surgical procedure or treatment program or drug regime, or other activities of industrial application in accordance with exemplary embodiments of the present invention.

FIG. 5 shows a schematic block diagram of a trading platform for facilitating trading in a financial instrument, for facilitating simulating or carrying out a medical or surgical procedure or treatment program or drug regime, or other activities of industrial application in accordance with exemplary embodiments of the present invention.

FIG. 6 illustrates a schematic exemplary diagram of the data that is contemporaneously displayed to a trader; non specialist doctor or medical or surgical practitioner or other person engaged in industrially applicable activity.

FIG. 7 graphically illustrates an exemplary screen showing a histogram of a market trend for a rate between the dollar to the euro; and

FIG. 8 illustrates an exemplary screen showing pie chart a market trend for a plurality of currency pairs.

### DESCRIPTION OF PREFERRED EMBODIMENTS

The following description is provided, along all chapters of the present invention, so as to enable any person to make use of said invention and sets forth the best modes contemplated by the inventor of carrying out this invention. As is customary. it will be understood that no limitation of the scope of the invention is thereby intended. Further modifications will remain apparent to those skilled in the art, since the generic principles of the present invention have been defined specifically to provide means and methods for managing and contemporaneously displaying data on a screen which enables a user to execute decisions whilst monitoring decisions made by others, and also monitoring trends in real time.

It will be apparent to those skilled in the art that such systems and methods described herein have many applications including , in a non limiting manner, making computerised decisions in the medical or surgical field, diagnostic field, processing technology, strategy development, investing, trading, intelligence gathering, agricultural goods allocation and development, resource allocation, commodity planning, human resource planning and many other areas of industrial endeavour.

Reference is now made to a method for contemporaneously displaying data on a screen; the method comprising the steps of:
viii. receiving a request for facilitating the selection of an executable operation from a list of possible operations
ix. retrieving a first on line data related to a change in a value of the outcomes of executing said operation;
x. retrieving from a data repository a second data related to preferences, activities and performance of one or more strategy providers; and
xi. contemporaneously transmitting the first data and the second data to a remote computerised device for making the first data and the second data contemporaneously available on a display of the remote computerised device.

Reference is now made to the aforementioned method further comprising a step of receiving an instruction for buying a financial instrument

Reference is now made to the aforementioned method further comprising a step of receiving an instruction for carrying out a medical or surgical procedure

Reference is now made to the aforementioned method further comprising a step of receiving an instruction for carrying out a drug regime.

Reference is now made to the aforementioned method further comprising a step of receiving an instruction for carrying out a logistical procedure

Reference is now made to the aforementioned method further comprising a step of receiving an instruction for carrying out a processing operation

Reference is now made to the aforementioned method further comprising a step of executing said instruction.

Reference is now made to the aforementioned method further comprising a step of executing said instruction, wherein the manner of said executing is selected from the group consisting of facilitating, operating, communicating, exchanging, replacing, directing, placing, locating, supplying, determining, finding, selecting, acquiring, removing, divesting, adding, subtracting, contracting, contacting, buying, selling, categorising, simulating, classifying, displaying, calculating, downloading, uploading, pushing. pulling and sending.

Reference is now made to the aforementioned method further comprising a step of receiving a selling order for selling a financial instrument.

Reference is now made to the aforementioned method further wherein said financial instrument comprises one member of the group consisting of securities, options, shares, bonds and mutual funds.

Reference is now made to the aforementioned method further comprising a step of executing the selling order.

Reference is now made to the aforementioned method further comprising steps of retrieving any data wherein the retrieving further comprising retrieving a third data related to a trend for said outcome and contemporaneously transmitting further comprises the third data.

Reference is now made to the aforementioned method wherein the first data further comprises a data related to a range in value of said outcome at predefined time frames.

Reference is now made to the aforementioned method further wherein said outcome is a difference between between a first value and a second value of an object or instrument.

Reference is now made to the aforementioned method further comprising a step of configuring the display of the remote computerised device wherein said steps further comprise configuring said display such that said first data, second data are displayed in separate fields on said display.

Reference is now made to the aforementioned method further comprising steps comprising configuring said display of the remote computerised device such that said third data are displayed in separate fields on said display.

Reference is now made to a computerized apparatus for for contemporaneously displaying data on a screen providing a user with contemporaneous strategy provider information, preferences and decisions in a computer implemented trading platform the computerized apparatus comprising:

a receiver module (110) configured for receiving a request for selecting of an executable operation from a list of possible operations

a processor module (120) configured for retrieving a first data related to a change in a value of the outcomes of executing said operation and for retrieving a second data related to preferences, performance and activity of strategy providers;

a transmitter module (130) configured for contemporaneously transmitting the first data and the second data; for making the first data and the second data contemporaneously available to the user on a display on a remote computer device wherein the processor is further configured for retrieving an information of a third data related to a trend for the outcomes of executing said operation and wherein the transmitter module is further configured for contemporaneously transmitting the third data.

Reference is now made to the aforementioned computerized apparatus wherein said receiver module is configured to receive an instruction for buying a financial instrument

Reference is now made to the aforementioned computerized apparatus configured to receive an instruction for carrying out a medical or surgical procedure

Reference is now made to the aforementioned computerized apparatus wherein said receiver module is configured to receive an instruction for carrying out a drug regime.

Reference is now made to the aforementioned computerized apparatus wherein said receiver module is configured to receive an instruction for carrying out a logistical procedure

Reference is now made to the aforementioned computerized apparatus wherein said receiver module is configured to receive an instruction for carrying out a processing operation

Reference is now made to the aforementioned computerized apparatus wherein said receiver module is configured to receive a step of executing said instruction.

Reference is now made to the aforementioned computerized apparatus wherein the manner of said executing is selected from the group consisting of operating, communicating, exchanging, replacing, directing, placing, locating, supplying, determining, finding, selecting, acquiring, removing, divesting, adding, subtracting, contracting, contacting, buying, selling, displaying, calculating, downloading, uploading, pushing, pulling and sending.

Reference is now made to the aforementioned computerized apparatus further configured for receiving a selling order for selling a financial instrument:

Reference is now made to the aforementioned computerized apparatus wherein said financial instrument comprises one member of the group consisting of securities, options, shares, bonds and mutual funds.

Reference is now made to the aforementioned computerized apparatus configured for executing the selling order.

Reference is now made to the aforementioned computerized apparatus wherein said processor is configured for retrieving a third data related to a trend for said outcome and the contemporaneously transmitting further comprises the third data.

Reference is now made to the aforementioned computerized apparatus wherein the processor is configured for processing said first data wherein said first data is related to a range in value of said outcome at predefined time frames.

Reference is now made to the aforementioned computerized apparatus wherein said transmitter module is configured to transmit said outcome wherein said outcome is a difference between between a first value and a second value of an object.

The term or phrase “instructions for carrying out” or “carry out” refers hereinafter to an instruction or instructions for carrying out or carry out, which, when received, processed and executed by any of the elements of the present invention, including the receiver module, processor module, transmitter module, screen, display or field within the display or screen enables a user to facilitate, manipulate, imitate, mirror, command, order, diagnose, operate, communicate, exchange, replace, direct, place, locate, supply, determine, find, select, acquire, remove, divest, add, subtract, contract, contact, buy, sell, categorise, simulate, classify, display, calculate, download, upload, push, pull and send.

The following are non limiting examples of an embodiment of the invention and terms used:

The term “Financial instrument” refers hereinafter to an evidence of an ownership interest in a financial entity; or a contractual right to receive, or deliver, cash or another financial instrument. A financial instrument may be related to foreign exchange market (FOREX) for example a rate between a first currency and a second currency such as

The term “strategy” refers to the approach of the expert. For example a strategy regarding a pair of currencies such as dollar to euro may be buying if another currency (for example the yen) goes up or selling if the value gold goes up and the link.

The term “strategy provider” refers hereinafter to a trader or an analyst that is an expert in the market his strategies and trading decisions can assist other traders in taking decisions by enabling the other traders to mirror the strategy provider's financial activities that are taken through the trading platform and by imitating his strategies and his financial activities.

The term “preferences of strategy providers” refers hereinafter to the strategies that are chosen by a strategy provider.

The term “financial activity of a strategy provider” refers hereinafter to financial activity that is performed via the trading platform. Such an activity include buying and selling orders, including statistical information regarding the buying or the selling orders as well as on line information.

The terms “market trend” and “sentiments” used interchangeably in the present disclosure refers hereinafter to a tendency of a financial market to move in a particular direction over time. The market trend can be reflected by showing the number of buy orders and the number of sale orders in timeframes.

The term “non professional trader” refers hereinafter to an investor who is a user or a subscriber of a trading platform who is typically unfamiliar with the market and who would like to get an assist before taking a decision.

The term “pairs of currencies” refers herein after to a pair of two currencies from which a difference between the rates of one currency to the other currency on a specific time frame is calculated.

The term “mirroring” refers herein to online viewing, through the trading platform, the strategy provider's financial activities and preferences, performance and the like. In some exemplary embodiments, the mirroring is live mirroring in which a trader can watch via the trading platform the trading and signals of one or more strategy providers and can join the trade. The term “mirroring” also refers, where appropriate, in a medical or surgical or industrial context, herein to online viewing by the non specialist user, through the platform, the specialist or specialist strategy provider's activities and preferences, performance and the like. In some exemplary embodiments, the mirroring is live mirroring in which a non specialist user can watch via the platform the activities, recommendations and signals of one or more strategy providers and can join the activity or imitate the activity.

One technical problem dealt with by the present disclosure is to facilitate a non expert trader of a financial instrument through a trading platform. Investing online, or self-directed investing, has become the norm for individual investors and traders with many brokers now offering online services with unique trading platforms. There is an unmet need to assist the trading platform user who is typically a non professional trader and is unfamiliar with the market.

One technical solution is to contemporaneously display trading information to assist the non professional trader; such information includes history and up to date information regarding the market and regarding the trends in the market. Additionally the information includes preferences and financial performance of one or more strategy providers and information regarding the trades that are executed by the strategy providers. The information is displayed contemporaneously for providing comprehensive information to a non professional trader and for assisting him in taking decisions. According to some embodiments, the trader can review, through the trading platform all the strategy providers, their background and their performance and, base on this information, can choose the providers that he wishes to mirror. According to some other embodiments, the trader can get on line data regarding the trades that are performed by the strategy providers that are chosen by him and can choose to join one or more trades.

One technical solution in a health care context is is to contemporaneously display medical, health and disease information to assist the non specialist health care user on the ground in a particular locality, when faced with a particular medical scenario. Such information includes history and up to date information regarding the macro situation, for example, during an epidemic or mass catastrophe and regarding the developing trends in the overall situation. Additionally the information includes preferences and performance of one or more specialist healthcare medical and surgical strategy providers and information regarding the procedures and actions that are executed by the strategy providers. The information to a non-specialist user and for assisting him in taking decisions. According to some embodiments, the trader can review, through the trading platform all the strategy providers, their background and their performance and, base on this information, can choose the providers that he wishes to mirror. According to some other embodiments, the trader can get on line data regarding the trades that are performed by the strategy providers that are chosen by him and can choose to join one or more trades.

### EXAMPLE 1

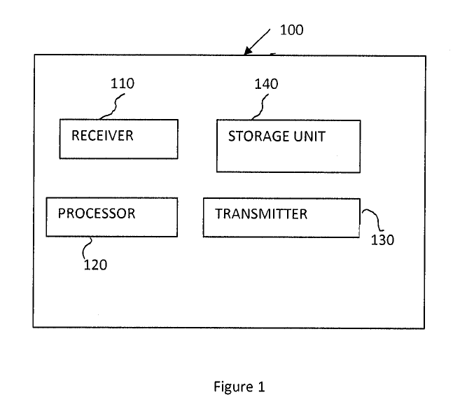

Reference is made now to FIG. 1 showing a schematic block diagram of a centralized machine for facilitating trading of a financial instrument, in accordance with some exemplary embodiments of the disclosure. The centralized machine may comprise one or more computer servers or any other computerized machine. According to some embodiments, the centralized machine serves a plurality of non professional traders who wish to trade one or more financial instruments by providing the non professional traders all the relevant information that is required for taking a decision regarding the trade. The relevant information includes preferences and on line activity of the strategy providers. According to some embodiments, the centralized machine 100 comprises a receiver 110, a processor 120, a transmitter 130, and a storage unit 140. According to some other embodiments, the storage unit 140 resides in an external device.

According to some embodiments, the receiver 110 is configured for receiving a request for facilitating trading of a financial instrument. The request may be received from one or more applications executed by one or more traders who wish to execute one or more trading of a financial instrument. In some embodiments the traders are non professional traders who wish to obtain online and off line information and, in particular, information about activities and strategies of strategy providers. Such information may assist the traders in the trading. The financial instrument may be securities, options, shares, bonds, mutual funds or rates between a first currency to a second currency; for example rate between a Dollar and an Euro and the like. The traders request online and historical information that may assist in executing the trade.

According to some embodiments, the processor 120 is configured for retrieving a first data related a value change of the financial instrument and for retrieving a second data related to preferences, performance and financial activities of the strategy providers. The first and the second data may be retrieved from the storage unit 140. In some embodiments, the first data further comprises a range in value of the financial instrument in pre defined time frames. For example, if the financial instruments are a currency rate between the Euro and the Yen, the range in value may be the range between the minimum value and the maximum value of the rate. Current value and rate of the financial instrument may be retrieved from the internet. In some other exemplary embodiments, the processor 120 is further configured for retrieving a third data representing a market trend for the financial instrument. The processor is further configured for directing on line traders that are performed by one or more strategy providers to one or more other traders.

According to some embodiments, the transmitter 130 is configured for contemporaneous transmitting the first data and the second data to the requestor. According to some other embodiments, the transmitter 130 is further configured for contemporaneously transmitting a third data or more. Contemporaneous transmitting of data enables to display the data contemporaneously on the screen of the user. According to some other embodiments the transmitters is further configured for transmitting in real time on line traders that are performed by one or more strategy providers to one or more other traders.

According to some embodiments, the storage unit 140 is configured for storing the first data, the first second and third data. Such data may comprise historical data related to trade values, to number of buys or to number of sales per a trade or information related to strategy providers. The information related to strategy providers may comprise background information about the strategy provider (experience etc). the preferences of the strategy provider, the trades performed by the strategy provider, the performance and the like.

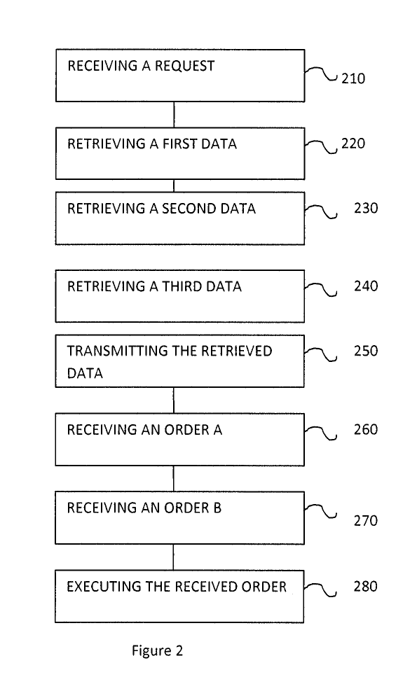

Referring now to FIG. 2, representing a flowchart diagram of a centralized method for facilitating trading of a financial instrument, in accordance with some exemplary embodiments of the disclosure. According to some embodiments, the method provides a service for a plurality traders who wish to trade one or more financial instruments by providing the traders all the relevant information that is required for taking a decision regarding the trade and in particular, by providing information regarding the activity and the preferences of strategy providers and by enabling the traders to execute the trade.

At 210 a request for facilitating of a trading of a financial instrument is received by one or more traders. In some embodiments, the traders are non professional traders who wish to get information regarding the market and regarding activities and preferences of strategy providers, before executing the trade.

At 220, a first data related to a change in a value of the financial instrument providers is retrieved. Historical data related to change in value may be retrieved from the storage unit, while online data such as the data related to the current rate may be retrieved from the one or more brokers such as FXCM.

At 230, a second data related to the preferences, financial activities and financial performances is retrieved. The data may be retrieved from storage.

At 240, a third data related to market trend for the financial instrument is retrieved. The data may be retrieved from storage.

At 250, the first and the second data and optionally other data are transmitted to the trader. In some embodiments, the first data further comprise a range in value of the financial instrument on pre defined time frames. According to some other embodiments, a third data related to market trend for the financial instrument is further transmitted. The transmitting of first data, the second data and the third data is contemporaneous for being displayed contemporaneously on a user computerized display. According to other embodiments, data related to trades that are performed by one or more strategy providers is transmitted to one or more traders. A trader can choose the strategy providers whom he wishes to mirror. When a trade is performed by a strategy provider that is chosen by the trader, the data related to the trade is transmitted in real time to the trader in order to enable the trader to imitate the trade.

At 260 an order for buying the financial instrument is received from the trader. According to some embodiments, the buying order is received after the trader received the information regarding the trade and decides to buy the financial instrument based upon the received information. According to some other embodiments, the order is received as a result of joining a trade of a strategy provider.

At 270 an order for selling the financial instrument is received from the trader. According to some embodiments, the buying order is received after the trader received the information regarding the trade and decides to sell the financial instrument based upon the received information. According to some other embodiments, the order is received as a result of joining a trade of a strategy provider

At 280, the selling or the buying order is executed.

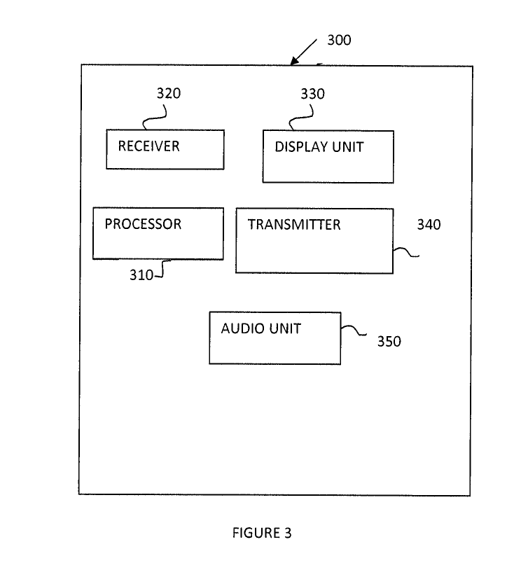

Referring now to FIG. 3 showing a schematic block diagram of a computerized apparatus for facilitating trading in a financial instrument, in accordance with some exemplary embodiments of the disclosure. The computerized apparatus may be a computer, a laptop, a cellular telephone and the like. According to some embodiments, the computerized apparatus may serve one or more non professional traders who wish to trade one or more financial instruments by enabling the traders to query for information related to the trade and by contemporaneously displaying the information to the traders. Such an information is related to a value change of the financial instrument to market trend and to preferences or financial activities of strategy providers and the like. Displaying the whole information on a computerized display provides a non provisional trader with knowledge related to the market and also provides information about the preferences and the trades that are performed by the strategy providers who are expert in the field.

According, to some embodiments, the apparatus comprises a processor 310, a receiver module 320 a display unit 330 and a transmitter module 340

According to some embodiments. the processor (310) for executing a request for facilitating a trading of said financial instrument.

According to some embodiments, the transmitter module 340 is configured for transmitting a request for retrieving data related to a financial instrument and for transmitting a selling order or a buying order and optionally other data or requests. The requests and the orders are transmitted to a centralized machine.

According to some embodiments, the receiving module 320 is configured for receiving data related to a value change of the financial instrument and for receiving data related to preferences and to financial activities of one or more strategy providers. According to some other embodiments, the receiving module 320 is further configured for receiving data related to a market trend for the financial instrument or any other data.

According to some embodiments, the received data related to the financial activities of one or more strategy providers reflects the actual trades and signals of the strategy providers. Thus, when a strategy provider performs a trade, the data related to the trade is received and displayed on the computerized apparatus of the trader, in order to enable the trader to join the trade. Thus a non-professional trader can imitate the trades of an expert and benefit from his experience.

According to some other embodiments, the display unit 330 is further configured for contemporaneously displaying the information received from the centralized machine and for providing graphical options (such as buttons) for performing buy order or a sell order. Displaying data may be by using graphs, charts, tables, histograms and the like or any other combination thereof. The displayed data includes generic data and data related to strategy providers. The generic data includes a value change of the financial instrument, market trend (sentiments), range in values and the like. The data related to strategy providers includes preferences, buy or sell orders, performance and the like. In some exemplary embodiments, the trades that are performed by one or more strategy providers are displayed on the display for enabling the user to join these trades.

According to some embodiments, the audio unit (350) is further configured for playing the information received from the centralized machine.

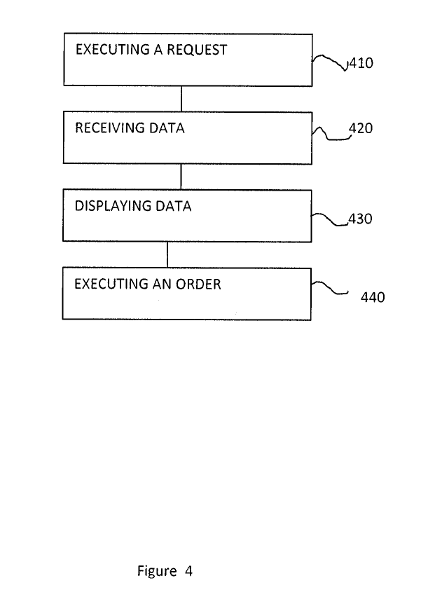

Reference is now made to FIG. 4 showing a flowchart diagram of a computerized method for facilitating trading in a financial instrument, in accordance with some exemplary embodiments of the disclosure. The method may be used by a computerized apparatus serving one or more traders who wish to trade one or more financial instruments.

At 410, a request for facilitating trading of a financial instrument is executed. The request may be executed as a result of a trader request. The request is transmitted to a centralized machine. The centralized machine retrieved the data that is related to the trading and transmits the information to the requestor.

At 420, the data sent by the centralized machine is received. The data includes a value change of the financial instrument and preferences of one or more strategy providers. In some other embodiments the information further includes market trend for the financial instrument. In some exemplary embodiments, the data includes range in value of the financial instrument in pre defined time intervals.

At 430, the received data is contemporaneously displayed on a display unit in order to provide comprehensive information to a user. Displaying the data may be by using graphs, charts, tables, histograms and the like or any other combination thereof.

In some exemplary embodiments, the data that is displayed includes the trades of one or more strategy providers to enable the trader to mirror the trades and the financial activities of the strategy provider and to enable him to join one or more trades.

At 440 a buying order or a selling order is issued as a result of a request of the trader.

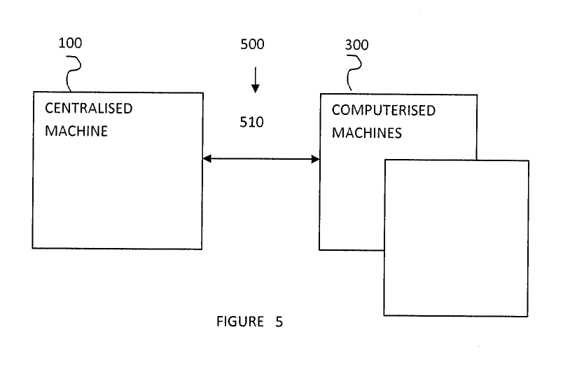

Referring now to FIG. 5 showing a schematic block diagram of a trading platform 500 for facilitating trading in a financial instrument, in accordance with some exemplary embodiments of the disclosure. Trading platform 500 includes one or more centralized machines 100 for receiving requests for facilitating trading in a financial instrument from a plurality of traders. The one or more centralized machines 100 retrieve the information related to the trading and transmit the information to the trader. The trading platform 500 also include one or more computerized machines 300 used by one or more traders. The computerized machine 300 includes a display for enabling the user to issue a request for facilitating trading in a financial instrument. for displaying the information that is received from the centralized machine 100 and for enabling the user to issue a buy or a sell request. The computerized machine 300 and the centralized machine 100 may communicate via the interne cloud 510.

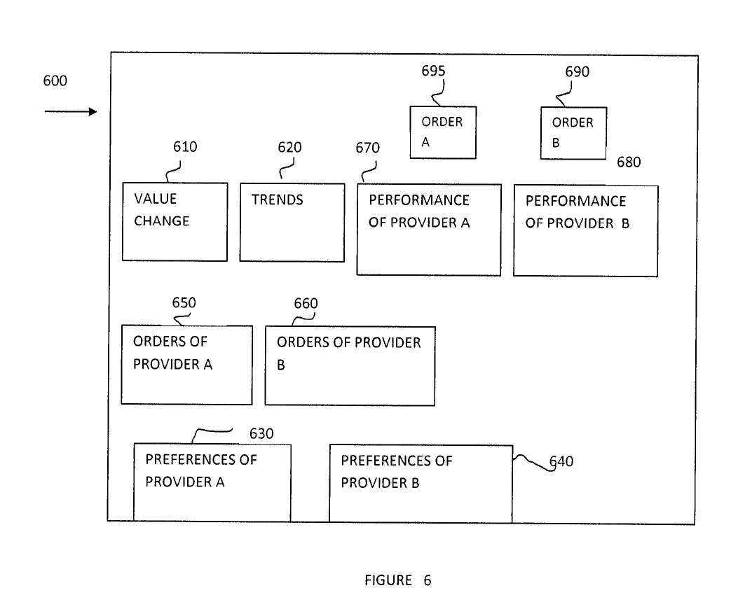

Referring now to FIG. 6 which illustrates a schematic diagram of data that is contemporaneously displayed for the trader on a display of a computerized machine. Such a data may be displayed on a computerized screen of a trader for assisting him in the trade. In some exemplary embodiments, the trader first chose the type of trade he wishes to perform. For example, the trader may use to trade in one or more pair of currencies, for example, dollar to Euro, dollar to yen, and dollar to sterling. In some embodiments, the trader chooses one or more strategy providers from whom he wishes to learn and optionally to mirror their financial decisions and preferences. Choosing is done according to background information about strategy provider (for example, cubiculum vita), performance of the provider, the strategies used by the provider and the like. After choosing the strategy providers, the trader requests information from the trading platform regarding the trades, regarding the financial activities and the preferences of the strategy providers. The information is received and displayed on the screen and enables the trader to execute a buy and/or a sell order. FIG. 6 illustrates an exemplary display of a trader who chooses to learn from providers A and B regarding a specific financial instrument. Display 600 shows a graph illustrating a value change in the financial instrument 610, a graph representing the trends (sentiments) of the market 620. Additionally display 600 includes a graphical presentation of the preferences of the service provider A 630, a graphical presentation of the preferences of the service provider B 640, a graphical representation of the buying and selling orders of service provider A 650, graphical representation of the buying and selling orders of service provider B 660, a graphical presentation of the performance of service provider A 670 and a graphical presentation of the performance of service provider B 680. The trader can, at any time based on the presented information choose to either sell the financial instrument by clicking on the sell button 690, or buy the financial instrument by clicking on the buy button 695.

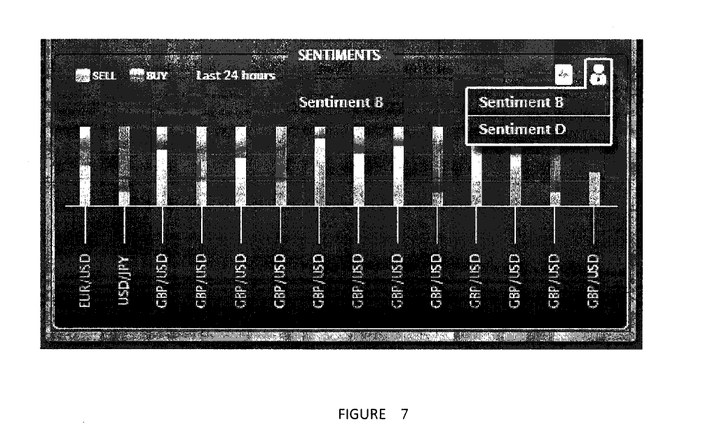

Referring now to FIG. 7 which graphically illustrate an exemplary screen showing a histogram 700 of a market trend and the preferences of the strategy providers for a rate between the dollar to the euro.

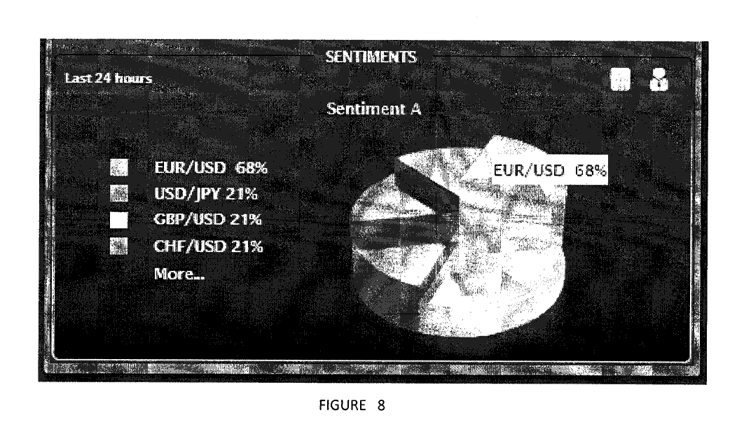

Referring now for FIG. 8 which illustrates an exemplary screen showing pie chart 800 of a market trend for a plurality of currency pairs.

### EXAMPLE 2

Reference is again made to FIG. 1 showing a schematic block diagram of a centralized machine for facilitating carrying out a medical or surgical procedure, in accordance with some exemplary embodiments of the disclosure. The centralized machine may comprise one or more computer servers or any other computerized machine. According to some embodiments, the centralized machine serves a plurality of non specialist medical or surgical practioners who wish to carry out a medical or surgical procedure or a health related action. They are provided with the relevant information that is required for taking a decision regarding the medical or surgical procedure. The relevant information includes preferences and on line activity of medical or surgical specialists and medical or surgical strategy providers. According to some embodiments, the centralized machine 100 comprises a receiver 110, a processor 120, a transmitter 130, and a storage unit 140. According to some other embodiments, the storage unit 140 resides in an external device.

According to some embodiments, the receiver 110 is configured for receiving a request for facilitating carrying out a medical or surgical procedure or activity. The request may be received from one or more applications executed by one or more non specialist medical or surgical practitioners who wish to execute one or more medical or surgical procedures. In some embodiments the medical or surgical practitioners are non specialists, nurses or paramedics who, under emergency or stressed circumstances or mass casualty or epidemic situations wish to obtain online and off line information and, in particular, information about activities and strategies of medical or surgical specialists or medical or surgical strategy providers. Such information may assist the non specialists in the medical or surgical procedures. The non specialists request online and historical information that may assist in executing the medical or surgical procedure.

According to some embodiments, the processor 120 is configured for retrieving a first data related a value change of the medical or surgical status and for retrieving a second data related to preferences, performance and activities of the medical specialists or medical or surgical strategy providers. The first and the second data may be retrieved from the storage unit 140. In some embodiments, the first data further comprises a range in value of the medical or surgical status in pre defined time frames. For example, during an epidemic or nuclear attack there may be changes in value of the medical or surgical status parameters. Current medical or surgical and epidemiological status and casualty rates may be retrieved from the internet. In some other exemplary embodiments, the processor 120 is further configured for retrieving a third data representing a trend for the medical or surgical situation or disease. The processor is further configured for directing medical or surgical practitioners to one or more other medical or surgical practitioners.

According to some embodiments, the transmitter 130 is configured for contemporaneous transmitting the first data and the second data to the requestor/user. According to some other embodiments, the transmitter 130 is further configured for contemporaneously transmitting a third data or more. Contemporaneous transmitting of data enables display of the data contemporaneously on the screen of the user. According to some other embodiments the transmitters is further configured for transmitting in real time medical or surgical practitioners who are on line to one or more other medial practitioners.

According to some embodiments, the storage unit 140 is configured for storing the first data, the first second and third data. Such data may comprise historical data related to medical or surgical status values, to number of medical or surgical procedures, or to number of casualties or information related to medical or surgical strategy providers. The information related to strategy providers may comprise background information about the specialist medical or surgical strategy provider (experience etc), the preferences of the specialist strategy provider, the procedures performed by the strategy provider, the performance and the like.

Referring now to FIG. 2, representing a flowchart diagram of a centralized method for facilitating carrying out a medical or surgical procedure, in accordance with some exemplary embodiments of the disclosure. According to some embodiments, the method provides a service for a plurality of non specialist medical or surgical doctors who wish to carry out a medical or surgical procedure by providing the non specialist doctors all the relevant information that is required for taking a decision regarding the procedure and, particular, by providing information regarding the activity and the preferences of medical or surgical specialists and medical or surgical strategy providers and by enabling the non specialist doctors to execute the procedure.

At 210 a request for facilitating a medical or surgical procedure is received by one or more non specialist doctors. In some embodiments, the users are nurses or paramedics who wish to get information regarding the medical or surgical situation and regarding activities and preferences of specialist doctors and medical or surgical strategy providers, before executing the procedure.

At 220, a first data related to a change in a value of the medical or surgical status is retrieved. Historical data related to change in value may be retrieved from the storage unit, while online data such as the data related to the current value may be retrieved from the one or more information sources.

At 230, a second data related to the preferences, activities and performances is retrieved. The data may be retrieved from storage.

AT 240, a third data related to a medical or surgical outcome trend for the medical or surgical situation is retrieved. The data may be retrieved from storage.

At 250, the first and the second data and optionally other data are transmitted to the non specialist doctor. In some embodiments, the first data further comprise a range in value of the medical or surgical outcomes on pre defined time frames. According to some other embodiments, a third data related to a trend for the medical or surgical outcome is further transmitted. The transmitting of first data, the second data and the third data is contemporaneous for being displayed contemporaneously on a user computerized display. According to other embodiments, data related to medical or surgical procedures that are performed by one or more medical or surgical specialists or medical or surgical strategy providers is transmitted to one or more non specialist doctors. A non specialist doctor can choose the specialist doctor or doctors or medical or surgical strategy providers whom he wishes to mirror. When a procedure is performed by a strategy provider that is chosen by the user non specialist doctor, the data related to the procedure is transmitted in real time to the user non specialist doctor in order to enable the user non specialist doctor to imitate the medical or surgical procedure.

At 260 an order for carrying out a medical or surgical procedure is received from the user non specialist doctor. According to some embodiments, the order is received after the user non specialist doctor received the information regarding the procedure and decides to carry out the procedure based upon the received information. According to some other embodiments, the order is received as a result of joining a medical or surgical project or team of a medical or surgical strategy provider.

At 270 an instruction for facilitating a medical or surgical procedure or activity is received from the user non specialist doctor. According to some embodiments, the facilitation order is received after the non specialist doctor has received the information regarding the medical or surgical situation or procedure and decides to carry out or join in the medical or surgical effort based upon the received information.

At 280, the instruction for facilitating a medical or surgical procedure or activity is executed.

Referring now to FIG. 3 showing a schematic block diagram of a computerized apparatus for facilitating instructions for a medical or surgical procedure or activity, in accordance with some exemplary embodiments of the disclosure. The computerized apparatus may be a computer, a laptop, a cellular telephone and the like. According to some embodiments, the computerized apparatus may serve one or more non specialist doctors who wish to carry out a medical or surgical procedure or join an ad hoc medical or surgical team by enabling the user non specialist doctors to query for information related to the medical or surgical procedure or medial situation and by contemporaneously displaying the information to the user non professional doctors. Such an information is related to a value change of the medical or surgical status, trend and to preferences or activities of medical or surgical specialists and/or medical or surgical strategy providers and the like. Displaying the whole information on a computerized display provides a non specialist doctor with knowledge related to the medical or surgical situation and also provides him information about the preferences and the medical or surgical procedures that are performed by the specialist doctors and medical or surgical strategy providers who are expert in the medical or surgical field.

According to some embodiments, the apparatus comprises a processor 310, a receiver module 320 a display unit 330 and a transmitter module 340

According to some embodiments, the processor (310) for executing a request for facilitating a decision making process concerning a medical or surgical or surgical procedure or other medical or surgical or surgical activity.

According to some embodiments, the transmitter module 340 is configured for transmitting a request for retrieving data related to a financial instrument and for transmitting order A or order B from a range of possible orders and optionally other data or requests. The requests and the orders are transmitted to a centralized machine.
According to some embodiments, the receiving module 320 is configured for receiving data related to a value change of the medical or surgical situation and for receiving data related to preferences and to activities of one or more medical or surgical strategy providers. According to some other embodiments, the receiving module 320 is further configured for receiving data related to a medical or surgical trend for the medical or surgical outcome or any other data. According to some embodiments, the received data related to the activities of one or more strategy providers reflects the actual medical or surgical procedures and recommendations of the specialist doctor or medical or surgical strategy providers. Thus, when a strategy provider performs or recommends a procedure , the data related to the medical or surgical procedure is received and displayed on the computerized apparatus of the non specialist doctor, in order to enable the non specialist doctor to participate in the medical or surgical procedure or join a medical or surgical team or medical or surgical effort. Thus a non-specialist doctor can imitate the procedures of an expert and benefit from his experience.

According to some other embodiments, the display unit 330 is further configured. for contemporaneously displaying the information received from the centralized machine and for providing graphical options (such as buttons) for performing a medical or surgical procedure or drug regime. Displaying data may be by using graphs, charts, tables, histograms and the like or any other combination thereof The displayed data includes generic data and data related to strategy providers. The generic data includes a value change of the medical or surgical status of a case or cases, trends, recommendation trends, range in values and the like. The data related to strategy providers includes preferences, proceed with one operation or another or not, performance and the like. In some exemplary embodiments, the medical or surgical procedures that are performed by one or more strategy providers are displayed on the display for enabling the user to join these activities.

According to some embodiments, the audio unit (350) is further configured for playing the information received from the centralized machine.

Referring now to FIG. 4 showing a flowchart diagram of a computerized method for facilitating decision making prior to or during a medical or surgical procedure, in accordance with some exemplary embodiments of the disclosure. The method may be used by a computerized apparatus serving one or more non specialist doctors who wish to carry out a medical or surgical procedure or activity

At 410, a request for facilitating a medical or surgical procedure or activity is executed. The request may be executed as a result of a user request. The request is transmitted to a centralized machine. The centralized machine retrieved the data that is related to the medical or surgical case or situation and transmits the information to the requestor.

At 420, the data sent by the centralized machine is received. The data includes a value change of the medical or surgical status and preferences of one or more strategy providers. In some other embodiments the information further includes medical or surgical outcome trends for the medical or surgical condition. In some exemplary embodiments, the data includes range in value of medical or surgical outcomes in pre defined time intervals.

At 430, the received data is contemporaneously displayed on a display unit in order to provide comprehensive information to a user. Displaying the data may be by using graphs, charts, tables, histograms and the like or any other combination thereof.

In some exemplary embodiment, the data that is displayed includes the medical or surgical procedures or activities of one or more medical or surgical strategy providers to enable the non specialist doctor to mirror or imitate the medical or surgical procedures and activities of the strategy provider and to enable him to participate in or join one or more medical or surgical procedures, operations , activities or teams.

At 440 a medical or surgical or a surgical order is issued as a result of a request of the non specialist doctor.

Referring now to FIG. 5 showing a schematic block diagram of a medical or surgical information platform 500 for facilitating medical or surgical decision making, in accordance with some exemplary embodiments of the disclosure. The platform 500 includes one or more centralized machines 100 for receiving requests for facilitating medical or surgical procedures from a plurality of non specialist doctors. The one or more centralized machines 100 retrieve the information related to the trading and transmit the information to the non specialist doctor. The platform 500 also includes one or more computerized machines 300 used by one or more non specialized doctors. The computerized machine 300 includes a display for enabling the user to issue a request for facilitating a medical or surgical procedure or medical or surgical activity, for displaying the information that is received from the centralized machine 100 and for enabling the user to issue a medical or surgical or a surgical request. The computerized machine 300 and the centralized machine 100 may communicate via the interne cloud 510.

Referring, to FIG. 6 illustrates a schematic diagram of data that is contemporaneously displayed for the user non specialist doctor on a display of a computerized machine. Such a data may be displayed on a computerized screen of a user for assisting him in a medical or surgical procedure or medical or surgical or surgical activity. In some exemplary embodiments, the non specialist doctor first chooses the type of procedure he wishes to perform. For example. faced with a particular medical or surgical situation the non specialist doctor may wish to choose between a radical approach or a conservative standard approach. In some embodiments, the non specialist doctor chooses one or more medical or surgical strategy providers from whom he wishes to learn and optionally to mirror or imitate their medical or surgical or surgical decisions and preferences. Choosing is done according to background information about the strategy provider (for example, status in the wider medical or surgical community), performance of the provider, the strategies used by the provider and the like. After choosing the strategy providers, the non specialist doctor requests information from the medical or surgical information platform regarding the procedures , regarding the past outcomes and the preferences of the strategy providers. The information is received and displayed on the screen and enables the trader to make an informed medical or surgical or surgical decision. FIG. 6 illustrates an exemplary display of a non specialist doctor who chooses to learn from medical or surgical strategy providers A and B regarding a specific medical or surgical procedure, medical or surgical condition or medical or surgical situation. Display 600 shows a graph illustrating a value change in the medical or surgical outcome 610, a graph representing the trends 620. Additionally display 600 includes a graphical presentation of the preferences of the medical or surgical experts or medical or surgical strategy provider A 630, a graphical presentation of the preferences of the medical or surgical experts or medical or surgical strategy provider B 640, a graphical representation of the decisions or recommendations of expertise provider A 650, graphical representation of the decisions or recommendations of expertise provider B 660, a graphical presentation of the performance of provider A 670 and a graphical presentation of the performance of provider B 680. The user non specialist doctor can, at any time based on the presented information choose to either instruct a particular procedure by clicking on the button 690, or choose another procedure by clicking on the button 695.

1-31. (canceled)

32. A method for contemporaneously displaying data on a screen; the method comprising the steps of:
i. receiving a request for facilitating the selection of an executable operation from a list of possible operations
ii. retrieving a first on line data related to a change in a value of the outcomes of executing said operation;
iii. retrieving online second data related to preferences, activities and performance of one or more strategy providers; and
iv. contemporaneously transmitting the first data and the second data to a remote computerised device for making the first data and the second data contemporaneously available on a display of the remote computerised device.

33. The method of claim 32, further comprising at least one step selected from a group consisting of:
i. receiving an instruction for buying a financial instrument;
ii. receiving an instruction for carrying out a medical or surgical procedure;
iii. receiving an instruction for carrying out a drug regime;
iv. receiving an instruction for carrying out a logistical procedure;
v. receiving an instruction for carrying out a processing operation;
vi. executing said instruction; and
vii. receiving a selling order for selling a financial instrument.

34. The method of claim 32, wherein the manner of said executing is selected from the group consisting of operating, communicating, exchanging, replacing, directing, placing, locating, supplying, determining, finding, selecting, acquiring, removing, divesting, adding, subtracting, contracting, contacting, buying, selling, categorising, simulating, classifying, displaying, calculating, downloading, uploading, pushing, pulling and sending.

35. The method of claim 32, wherein said financial instrument comprises one member of the group consisting of securities, options, shares, bonds and mutual funds.

36. The method of claim 32, further comprising executing the selling order.

37. The method of claim 32, wherein the retrieving further comprising retrieving a third data related to a trend for said outcome and the contemporaneously transmitting further comprises the third data.

38. The method of claim 32, wherein the first data further comprises a data related to a range in value of said outcome at predefined time frames.

39. The method of claim 32; wherein said outcome is a difference between between a first value and a second value of an object or instrument.

40. The method of claim 32; wherein said steps further comprise configuring said display of the remote computerised device such that said first data, second data are displayed in separate fields on said display.

41. The method of claim 32; wherein said steps further comprise configuring said display of the remote computerised device such that said third data are displayed in separate fields on said display.

42. A computerized apparatus for contemporaneously displaying data on a screen providing a user with contemporaneous strategy provider information, preferences and decisions in a computer implemented trading platform; the computerized apparatus comprising:
i. a receiver module (110) configured for receiving a request for selecting of an executable operation from a list of possible operations;
ii. a processor (120) configured for retrieving a first data related to a change in a value of the outcomes of executing said operation and for retrieving online second data related to preferences, performance and activity of strategy providers;
iii. a transmitter module (130) configured for contemporaneously transmitting the first data and the second data; for making the first data and the second data contemporaneously available to the user on a display on a remote computer device wherein the processor is further configured for retrieving online information of a third data related to a trend for the outcomes of executing said operation and wherein the transmitter module is further configured for contemporaneously transmitting the third data.

43. The computerized apparatus of claim 42 wherein said receiver module is configured to perform an action selected from a group consisting of:
i. receive an instruction for buying a financial instrument
ii. ii. carrying out a medical or surgical procedure
iii. receive an instruction for carrying out a drug regime.
iv. receive an instruction for carrying out a logistical procedure
v. receive an instruction for carrying out a processing operation
vi. receive a step of executing said instruction.

44. The computerized apparatus of claim 42, wherein the manner of said executing is selected from the group consisting of operating, communicating, exchanging, replacing, directing, placing, locating, supplying, determining, finding, selecting, acquiring, removing, divesting, adding, subtracting, contracting, contacting, buying, selling, displaying, calculating, downloading, uploading, pushing, pulling and sending.

45. The computerized apparatus of claim 42, further configured for receiving a selling order for selling a financial instrument.

46. The computerized apparatus of claim 42, wherein said financial instrument comprises one member of the group consisting of securities, options, shares, bonds and mutual funds.

47. The computerized apparatus of claim 42, configured for executing the selling order.

48. The computerized apparatus of claim 42, wherein said processor is configured for retrieving a third data related to a trend for said outcome and the contemporaneously transmitting further comprises the third data.

49. The computerized apparatus of claim 42, wherein the processor is configured for processing said first data wherein said first data is related to a range in value of said outcome at predefined time frames.

50. The computerized apparatus of claim 42, wherein said transmitter module is configured to transmit said outcome wherein said outcome is a difference between between a first value and a second value of an object.
